(19) United States
(12) Patent Application Publication
(10) Pub. No.: US 2015/0221249 A1
(43) Pub. Date: Aug. 6, 2015

(54) BACKLIGHT UNIT AND DISPLAY APPARATUS HAVING THE SAME

(71) Applicant: Samsung Display Co., Ltd., Yongin-City (KR)

(72) Inventors: Kyunho KIM, Cheonan-si (KR); Youngsup KWON, Gwangmyeong-si (KR); Min-Gyu KIM, Asan-si (KR); Eun Chul SHIN, Cheonan-si (KR); Hwanwoong LEE, Asan-si (KR); Min-Soo CHOI, Asan-si (KR)

(21) Appl. No.: 14/469,619

(22) Filed: Aug. 27, 2014

(30) Foreign Application Priority Data
Feb. 3, 2014 (KR) 10-2014-0012183

(51) Int. Cl. G09G 3/20; G09G 3/34

(52) U.S. Cl. CPC G09G 3/2092; G09G 3/3413; G09G 2330/04; G09G 2330/025

(57) ABSTRACT

A backlight unit including, a controller configured to generate a control signal, a power converter configured generate a light-source voltage in response to the control signal, and at least one light emitting diode string connected between a first node and a second node and supplied with the light-source voltage from the first node, wherein the controller includes a current controller configured to adjust a current flow through the light emitting diode string, and an overvoltage controller connected between the light emitting diode string and the current controller, including a passive element, wherein the overvoltage controller is configured to connect the passive element between the second node and the current controller when a voltage of the second node of the light emitting diode is higher than a reference voltage.

### CROSS-REFERENCE TO RELATED APPLICATIONS

This application claims priority from and the benefit of Korean Patent Application No. 10-2014-0012183, filed on Feb. 3, 2014, which is hereby incorporated by reference for all purposes as if fully set forth herein.

### BACKGROUND

1. Field

Exemplary embodiments of the inventive concept described herein relate to a backlight unit and a display device including the same.

2. Discussion of the Background

As a user interface, a display device has become an essential component of an electronic device. A flat panel display device is typically used for implementation of light, thin, and low-power electronic devices.

The most common flat panel display device is a liquid crystal display (LCD) device. The LCD device is configured to receive light and display images by adjusting the amount of light received from the outside; hence, it includes a separate light source for providing a light to a liquid crystal panel. For example, the light source may be a backlight unit with a backlight lamp.

In recent years, low-power, slim, and eco-friendly LEDs (light emitting diodes) have been widely used as a light source. In such case, implementing uniform brightness and color over an entire display device is difficult in terms of optical design. Also, a high technology is required to instantly adjust a current of a light emitting diode for color combination.

The backlight unit contains a plurality of light emitting diode strings to provide brightness the display device requires. The same amount of current may be supplied to each of the plurality of light emitting diode strings for uniform brightness among each of the light emitting diode strings.

Each of the light emitting diode strings has a plurality of light emitting diodes that are connected in series. If a forward voltage across the serially-connected light emitting diodes is identical, upon providing the voltage to one end of the light emitting diode strings, the amount of current flowing via each of the light emitting diode strings may be constant.

In the event that forward voltages of light emitting diodes are different from one another because of a process variation, however, voltage levels of the other ends of the light emitting diode strings may be different from one another. Light emitting diodes may be damaged upon a sharp increase in a voltage level of the other end of any light emitting diode string.

The above information disclosed in this Background section is only for enhancement of understanding of the background of the invention and therefore it may contain information that does not form any part of the prior art nor what the prior art may suggest to a person of ordinary skill in the art.

### SUMMARY

Exemplary embodiments of the present inventive concept provide a backlight unit comprising a controller; a power converter configured to generate a light-source voltage in response to a control of the controller; and at least one light emitting diode string connected between a first node and a second node and supplied with the light-source voltage via the first node.

Exemplary embodiments of the present inventive concept also provide a display device including the same.

Additional features of the invention will be set forth in the description which follows, and in part will be apparent from the description, or may be learned by practice of the invention.

An exemplary embodiment of the present invention discloses a backlight unit including, a controller configured to generate a control signal, a power converter configured generate a light-source voltage in response to the control signal, and at least one light emitting diode string connected between a first node and a second node and supplied with the light-source voltage from the first node, wherein the controller includes a current controller configured to adjust a current flow through the light emitting diode string, and an overvoltage controller connected between the light emitting diode string and the current controller, including a passive element, wherein the overvoltage controller is configured to connect the passive element between the second node and the current controller when a voltage of the second node of the light emitting diode is higher than a reference voltage.

An exemplary embodiment of the inventive concept also provides a display device including a display panel including a plurality of pixels, a driver circuit configured to control the display panel so as to display images, and a backlight unit configured to supply a light to the display panel, wherein the backlight unit comprises a controller configured to generate a control signal, a power converter configured to generate a light-source voltage in response to the control signal; and at least one light emitting diode string connected between a first node and a second node and supplied with the light-source voltage from the first node, wherein the controller includes a current controller configured to adjust a current flow through the light emitting diode string, and an overvoltage controller connected between the light emitting diode string and the current controller, including a passive element, wherein the overvoltage controller is configured to connect the passive element between the second node and the current controller when a voltage of the second node of the light emitting diode is higher than a reference voltage.

With embodiments of the inventive concept, a backlight unit decreases a voltage level using a passive element when a voltage level of one of the other ends of light emitting diode strings sharply increases due to a difference between forward voltages of the light emitting diode strings. Thus, it is possible to limit the damage due to a difference between forward voltages of the light emitting diode strings.

It is to be understood that both the foregoing general description and the following detailed description are exemplary and explanatory and are intended to provide further explanation of the invention as claimed.

### BRIEF DESCRIPTION OF THE FIGURES

The accompanying drawings, which are included to provide a further understanding of the invention and are incorporated in and constitute a part of this specification, illustrate embodiments of the invention, and together with the description serve to explain the principles of the invention.

FIG. 1 is a block diagram schematically illustrating a display device according to an exemplary embodiment of the inventive concept.

FIG. 2 is a block diagram schematically illustrating a backlight unit shown in FIG. 1, according to an exemplary embodiment of the present inventive concept.

FIG. 3 is a block diagram schematically illustrating a controller shown in FIG. 2, according to an exemplary embodiment of the present inventive concept.

FIG. 4 is a circuit diagram schematically illustrating a first controller shown in FIG. 3, according to an exemplary embodiment of the present inventive concept.

FIG. 5 is a graph schematically illustrating a current-voltage characteristic of a light emitting diode string shown in FIG. 2.

FIG. 6 is a circuit diagram showing a current path when a voltage level of the other end of a light emitting diode string is at a normal level.

FIG. 7 is a circuit diagram showing a current path when a voltage level of the other end of a light emitting diode string is higher than a normal level.

FIG. 8 is a diagram an example where a first controller shown in FIG. 4 is implemented with an integrated circuit.

FIG. 9 is a circuit diagram schematically illustrating a first controller shown in FIG. 3, according to an exemplary embodiment of the present inventive concept.

FIG. 10 is a circuit diagram schematically illustrating a first controller shown in FIG. 3, according to an exemplary embodiment of the present inventive concept.

### DETAILED DESCRIPTION OF THE ILLUSTRATED EMBODIMENTS

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. It will be understood that for the purposes of this disclosure, “at least one of X, Y, and Z” can be construed as X only, Y only, Z only, or any combination of two or more items X, Y, and Z (e.g., XYZ, XYY, YZ, ZZ). Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

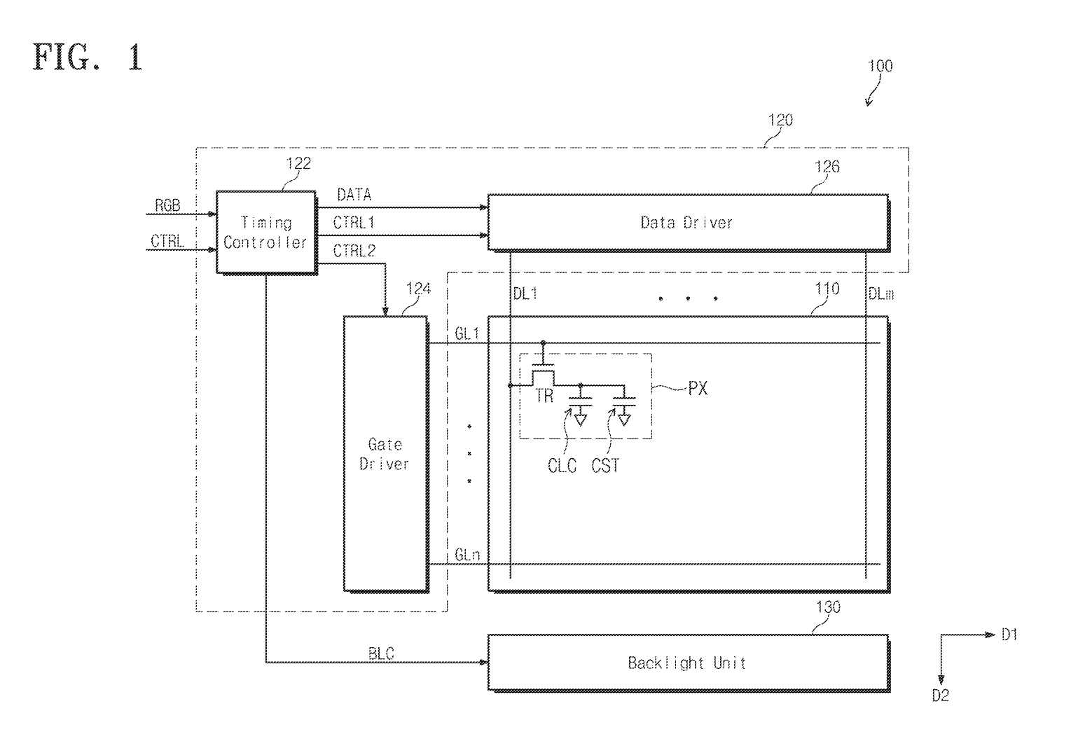

FIG. 1 is a block diagram schematically illustrating a display device according to an exemplary embodiment of the inventive concept.

Referring to FIG. 1, a display device 100 includes a display panel 110, a driver circuit 120, and a backlight unit 130.

The display panel 110 displays images. In exemplary embodiments, the display panel 110 may be a liquid crystal display panel, but the inventive concept is not limited thereto. For example, the display panel 110 may be any type of display panel that necessitates the backlight unit 130.

The display panel 110 may include a plurality of gate lines GL1 to GLn extending in a first direction D1, a plurality of data lines DL1 to DLm extending in a second direction D2, and a plurality of pixels PX arranged at each intersection between each of the plurality of gate lines GL1 to GLn and each of the plurality of data lines DL1 to DLm. The plurality of gate lines GL1 to GLn and the plurality of data lines DL1 to DLm are isolated from one another. Each pixel PX includes a thin film transistor TR, a liquid crystal capacitor CLC, and a storage capacitor CST.

Since each of the plurality of pixels PX have the same structure, its structure will be described using one pixel. The thin film transistor TR of the pixel PX has a gate electrode connected to a first gate line GL1 of the gate lines GL1 to GLn, a source electrode connected to a first data line DL1 of the data lines DL1 to DLm, and drain electrode connected to the capacitors CLC and CST. One ends of the capacitors CLC and CST are connected in parallel to the drain electrode of the thin film transistor TR, and the other ends thereof are connected to a common voltage.

The driver circuit 120 includes a timing controller 122, a gate driver 124, and a data driver 126. The timing controller 122 receives an image signal RGB and control signals CTRL from an external device. The control signals CTRL may include, for example, a vertical synchronization signal, a horizontal synchronization signal, a main clock signal, a data enable signal, etc. Based on the control signals CTRL, the timing controller 122 provides the data driver 126 with a data signal DATA and a first control signal CTRL1 and the gate driver 124 with a second control signal CTRL2. Here, the data signal may be generated by processing an image signal to be suitable for an operating condition of the display panel 110. The first control signal CTRL1 includes a horizontal synchronization start signal, a clock signal, and a line latch signal, and the second control signal CTRL2 includes a vertical synchronization start signal, an output enable signal, and a gate pulse signal.

The timing controller 122 changes the data signal DATA variably, based on arrangement of the pixels of the display panel 110 and a display frequency. The timing controller 122 provides the backlight unit 130 with a backlight control signal BLC for controlling the backlight unit 130.

The gate driver 124 drives the gate lines GL1 to GLn in response to the second control signal CTRL2 from the timing controller 122. The gate driver 124 may include a gate driver IC. The gate driver 124 may be implemented with a circuit using at least one of oxide semiconductor, amorphous semiconductor, crystalline semiconductor, polycrystalline semiconductor, etc.

The data driver 126 drives the data lines DL1 to DLm in response to the first control signal CTRL1 and the data signal DATA from the timing controller 122.

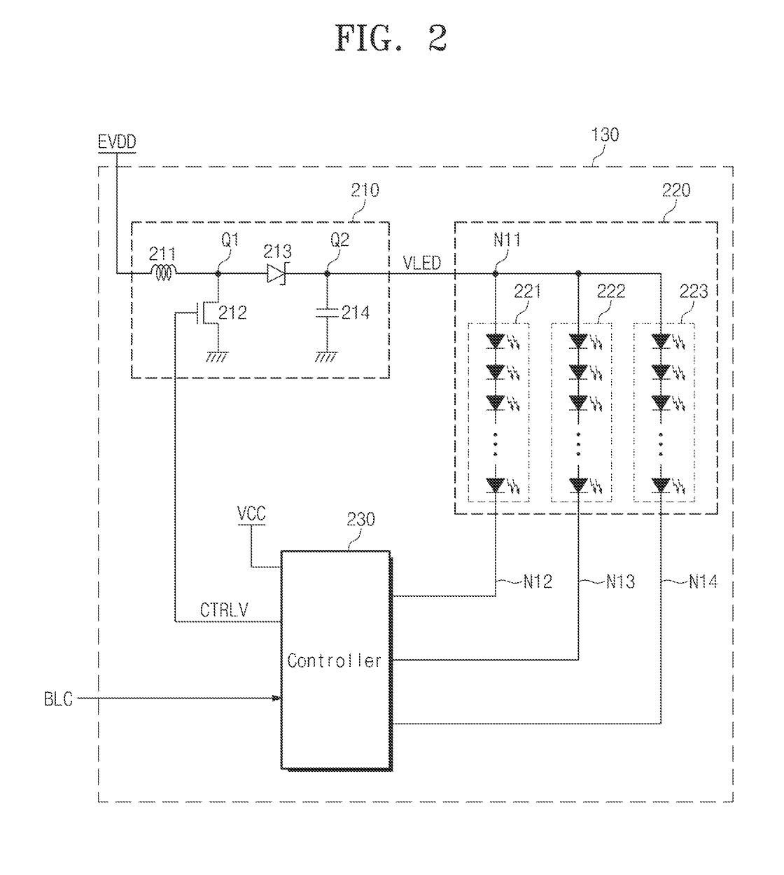

The backlight unit 130 is disposed under the display panel 110 to be opposite to the pixels PX. The backlight unit 130 operates in response to the backlight control signal BLC from the timing controller 122. A structure and an operation of the backlight unit 130 will be more fully described with reference to FIG. 2.

FIG. 2 is a block diagram schematically illustrating a backlight unit 130 shown in FIG. 1, according to an exemplary embodiment of the inventive concept.

Referring to FIG. 2, a backlight unit 130 includes a power converter 210, a light source 220, and a controller 230. The light source 220 includes a plurality of light emitting diode strings 221, 222, and 223. The exemplary embodiment illustrated in FIG. 2 shows that the light source 220 includes three light emitting diode strings 221, 222, and 223, but the inventive concept is not limited thereto. For example, the number of light emitting diode strings may be changed variously.

Each of the light emitting diode strings 221, 222, and 223 includes a plurality of light emitting diodes connected in series. The light emitting diodes may include a white light emitting diode emitting white light, a red light emitting diode emitting red light, a green light emitting diode emitting green light, and a blue light emitting diode emitting blue light. Emission characteristics of the white, red, green, and blue light emitting diodes are different from one another. In particular, the white, red, green, and blue light emitting diodes may each have different forward driving voltages Vf to emit light. Using Light emitting diodes with relatively lower forward driving voltage Vf may reduce overall power consumption. Also, a difference between forward driving voltages Vf of light emitting diodes may be decreased for uniform brightness. In exemplary embodiments, the light source 220 includes the light emitting diode strings 221, 222, and 223 formed of a plurality of light emitting diodes, but the inventive concept is not limited thereto. For example, the light source 220 may include at least one of laser diodes and carbon nano tubes.

One ends of the light emitting diode strings 221, 222, and 223 are connected to receive a light-source voltage VLED from the power converter 210 through a first node N11. The other ends of the light emitting diode strings 221, 222, and 223, that is, a second node N12, a third node N13, and a fourth node N14 are connected to the controller 230.

The power converter 210 converts a power supply voltage EVDD from an external device into the light-source voltage VLED. The light-source voltage VLED may be set to a voltage level sufficient for driving light emitting diodes of the light emitting diode strings 221, 222, and 223.

The power converter 210 includes an inductor 211, an NMOS transistor 212, a diode 213, and a capacitor 214. The inductor 211 is connected between a power supply voltage EVDD from an external device and a node Q1. The NMOS transistor 212 is connected between the node Q1 and a ground voltage and has a gate connected to receive a voltage control signal CTRLV from the controller 230. The diode 213 is connected between the node Q1 and a node Q2. In exemplary embodiments, the diode 213 may be formed of a Schottky diode. The capacitor 214 is connected between the node Q2 and the ground voltage. A light-source voltage VLED of the node Q2 is supplied to one ends of the light emitting diode strings 221, 222, and 223.

The power converter 210 converts the power supply voltage EVDD into the light-source voltage VLED. In particular, a level of the light-source voltage VLED may be adjusted by turning on or off the NMOS transistor 212 in response to the voltage control signal CTRLV.

The controller 230 receives a power supply voltage VCC. The controller 230 operates in response to a backlight control signal BLC from a timing controller 122 (refer back to FIG. 1). For example, the controller 230 responds to the backlight control signal BLC to generate a voltage control signal CTRLV, which may be used to determine whether to generate the light-source voltage VLED or to stop generating the light-source voltage VLED. Also, the controller 230 responds to the backlight control signal BLC to generate the voltage control signal CTRLV for adjusting a level of the light-source voltage VLED. The controller 230 is connected to second to fourth nodes N12 to N14, the other ends of the light emitting diode strings 221 to and 223, respectively.

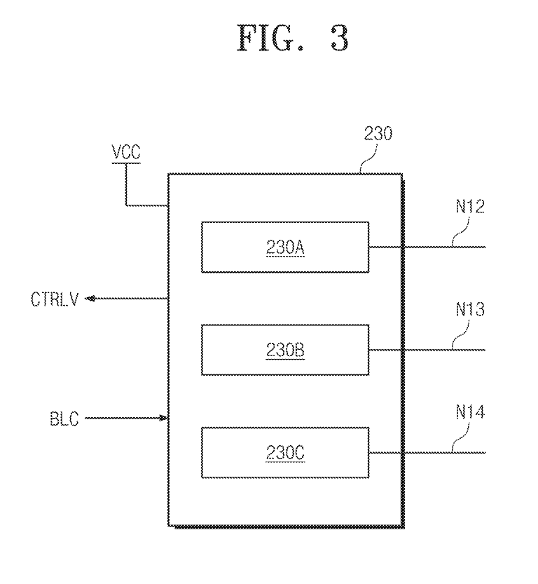

FIG. 3 is a block diagram schematically illustrating a controller 230 shown in FIG. 2, according to an exemplary embodiment of the inventive concept.

Referring to FIGS. 2 and 3, a controller 230 receives a power supply voltage VCC. The controller 230 generates a voltage control signal CTRLV in response to a backlight control signal BLC from a timing controller 122 (refer to FIG. 1). The controller 230 includes a first controller 230A, a second controller 230B, and a third controller 230C.

The first controller 230A, the second controller 230B, and the third controller 230C are respectively connected to the second node N12 connected to the other end of a light emitting diode string 221, the third node N13 connected to the other end of a light emitting diode string 222, and the fourth node N14 connected to the other end of a light emitting diode string 223.

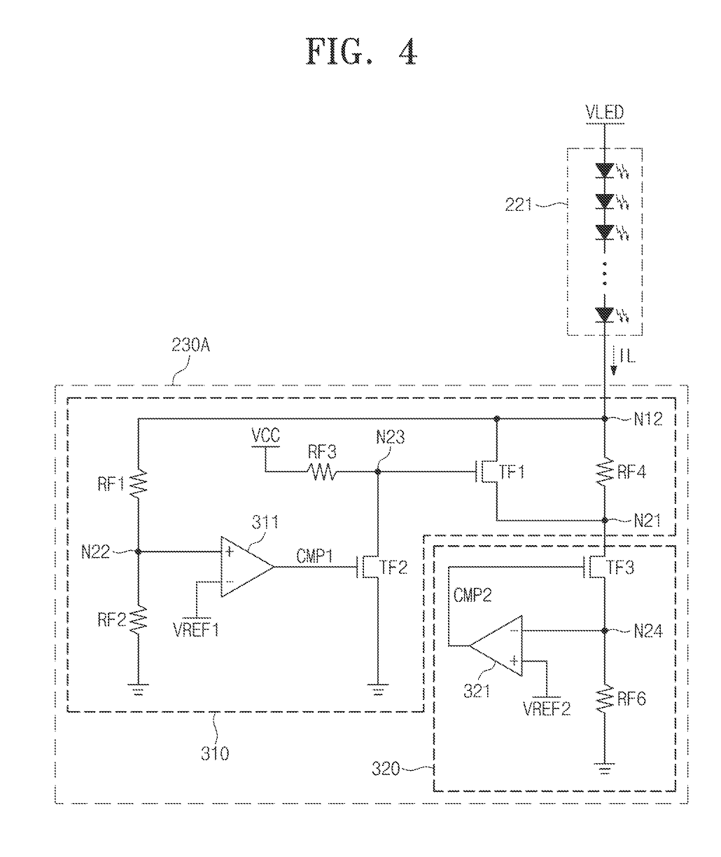

FIG. 4 is a circuit diagram schematically illustrating a first controller shown in FIG. 3, according to an exemplary embodiment of the inventive concept. In exemplary embodiments, first to third controllers shown in FIG. 3 may have the same configuration. Thus, FIG. 4 illustrates only the configuration of the first controller. In other words, the controller 230 includes a plurality of current controllers respectively corresponding to the plurality of light emitting diode strings 221, 222, and 223 and a plurality of overvoltage controllers respectively corresponding to the plurality of light emitting diode strings 221, 222, and 223. According to an exemplary embodiment of the present invention illustrated with reference to FIGS. 3 and 4, the controller 230 includes 3 current controllers and 3 overvoltage controllers, but the present invention is not limited thereto. The controller may also include a number of current controllers and a number of overvoltage controllers other than 3.

Referring to FIGS. 3 and 4, a first controller 230A includes an overvoltage controller 310 and a current controller 320. The overvoltage controller 310 includes first to fourth resistors RF1 to RF4, first and second transistors TF1 and TF2, and a comparator 331. The fourth resistor RF4 is connected between a second node N12 and a first internal node N21. In exemplary embodiments, the fourth resistor RF4 is used as a passive element connected between the second node N12 and the first internal node N21, but the present inventive concept is not limited thereto. For example, passive element connected between the second node N12 and the first internal node N21 may include at least one of a capacitor, an inductor, a diode, and the like.

The first transistor TF1 is connected in parallel with the fourth resistor RF4 between the second node N12 and the first internal node N21 and has a gate electrode connected to a third internal node N23. The first resistor RF1 and the second resistor RF2 are sequentially connected in series between the second node N12 and a ground voltage.

The first comparator 311 compares a voltage of a second internal node N22, a connection between the first resistor RF1 and the second resistor RF2, with a first reference voltage VREF1 and outputs a first comparison signal CMP1 as a comparison result. The third resistor RF3 is connected between the power supply voltage VCC and a third internal node N23. The second transistor TF2 is connected between the third internal node N23 and the ground voltage and has a gate electrode connected to the output of the first comparator 311 to receive the comparison signal CMP1.

The current controller 320 includes a third transistor TF3, a sixth resistor RF6, and a second comparator 321. The third transistor TF3 is connected between the first internal node N21 and a fourth internal node N24 and has a gate electrode connected to the output of the second comparator 321. The sixth resistor RF6 is connected between the fourth internal node N24 and the ground voltage. The second comparator 321 compares a voltage of the fourth internal node N24 with a second reference voltage VREF2 to output a second comparison signal CMP2. The second comparison signal CMP2 is provided to a gate electrode of the third transistor TF3.

When a voltage of the fourth internal node N24 is lower than the second reference voltage VREF2, the second comparator 321 outputs a high level of second comparison signal CMP2; hence, the third transistor TF3 is turned on. When a voltage of the fourth internal node N24 is higher than the second reference voltage VREF2, the second comparator 321 outputs a low level of second comparison signal CMP2. At this time, the third transistor TF3 is turned off by the low level of second comparison signal CMP2. As a turn-on time of the third transistor TF3 is decided according to a voltage of the fourth internal node N24, the current controller 320 adjusts the amount of current flowing via the light emitting diode string 221.

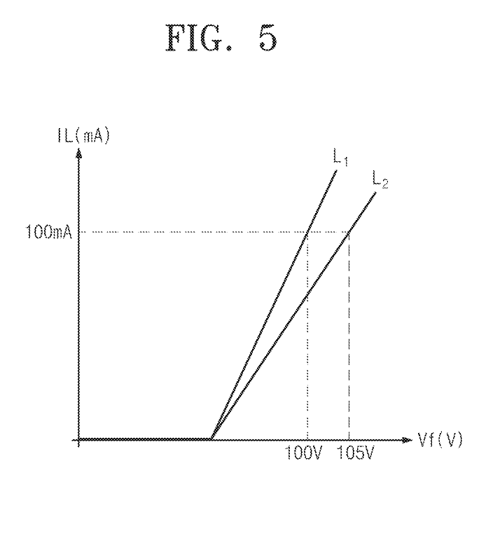

FIG. 5 is a graph schematically illustrating a current-voltage characteristic of a light emitting diode string shown in FIG. 2.

Referring to FIGS. 2 and 5, when a forward driving voltage Vf is about 100 V, a current IL of about 100 mA flows via a light emitting diode string 221, for example, as shown as line 1 (L1) of FIG. 5. When a forward driving voltage Vf is about 105 V, a current IL of about 100 mA flows via the light emitting diode string 222, for example, as shown as line 2 (L2) of FIG. 5. Applying different forward driving voltages Vf to different light emitting diode strings 221 and 222 for the same amount of current flows increases a potential between a second node N12, the other end of the light emitting diode string 221 with a relatively low forward driving voltage Vf, and a ground voltage. In the event that a drain electrode of a third transistor TF3 (refer to FIG. 4) is directly connected to a second node N12, a drain-source voltage Vds of the third transistor TF3 may increase. Increase in the drain-source voltage Vds of the third transistor TF3 may generate heat in the third transistor TF3. Such heat generation may be overheated the third transistor TF3 and may result in abnormal operation or damage.

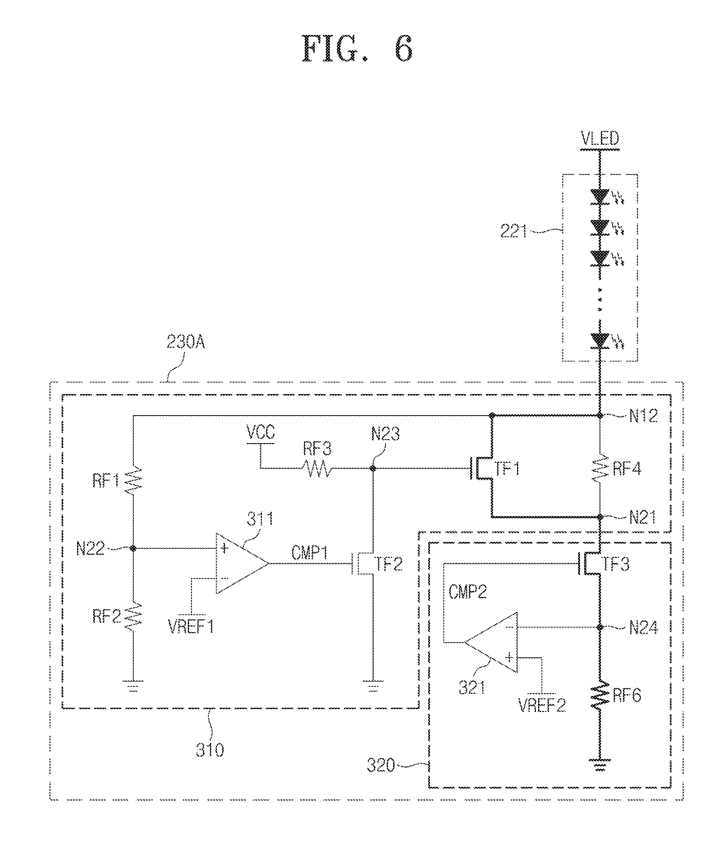

FIG. 6 is a circuit diagram showing a current path when a voltage level of the other end of a light emitting diode string is at a normal level.

Referring to FIG. 6, a first resistor RF1 and a second resistor RF2 divides a voltage of the second node N12, which is the other end of a light emitting diode string 221. When a voltage of the second internal node N22 is lower than a first reference voltage VREF1, a first comparator 311 outputs a low level of first comparison signal CMP1. While the first comparator 331 outputs a low level of the first comparison signal CMP1, a second transistor TF2 is turned off. Since a power supply voltage VCC is provided to a gate electrode of a first transistor TF1 via a resistor RF3, the first transistor TF1 is turned on. A drain-source resistance Rds of the first transistor TF1 may be smaller than a resistance of a fourth resistor RF4. Therefore, when the first transistor TF1 is turned on, a current supplied to the second node N12 flows into a third transistor TF3 through the first transistor TF1 and a first internal node N21.

That is, when a voltage level of the second node N12 is at a normal level, the first transistor TF1 is turned on, and the drain terminal of the third transistor TF3 of a current controller 320 is directly connected to the second node N12.

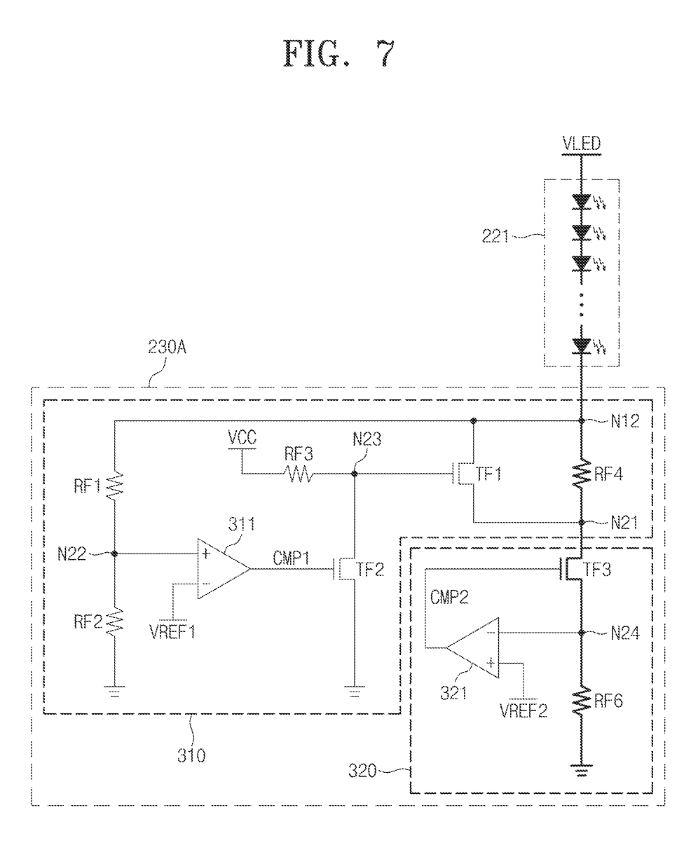

FIG. 7 is a circuit diagram showing a current path when a voltage level of the other end of a light emitting diode string is at a level higher than a normal level.

Referring to FIG. 7, when a voltage of the second internal node N22 is higher than a first reference voltage VREF1, a first comparator 311 outputs a high level of first comparison signal CMP1. The second transistor TF2 is turned on when the first comparator 331 outputs a high level of the first comparison signal CMP1. At this time, a voltage of the third internal node N23 is discharged to a ground voltage via the second transistor TF2, so the first transistor TF1 is turned off. This makes the current from the second node N12 flow to the first internal node N21 via the fourth resistor RF4. In other words, if a voltage level of the second node N12 is higher than a normal level, the first transistor TF1 is turned off; thus, the voltage provided to a drain terminal of a third transistor TF3 is dropped by the fourth resistor RF4. This may mean that an overvoltage may be limited from being supplied to the drain terminal of the third transistor TF3 when the voltage level of the second node N12 is higher than the normal level.

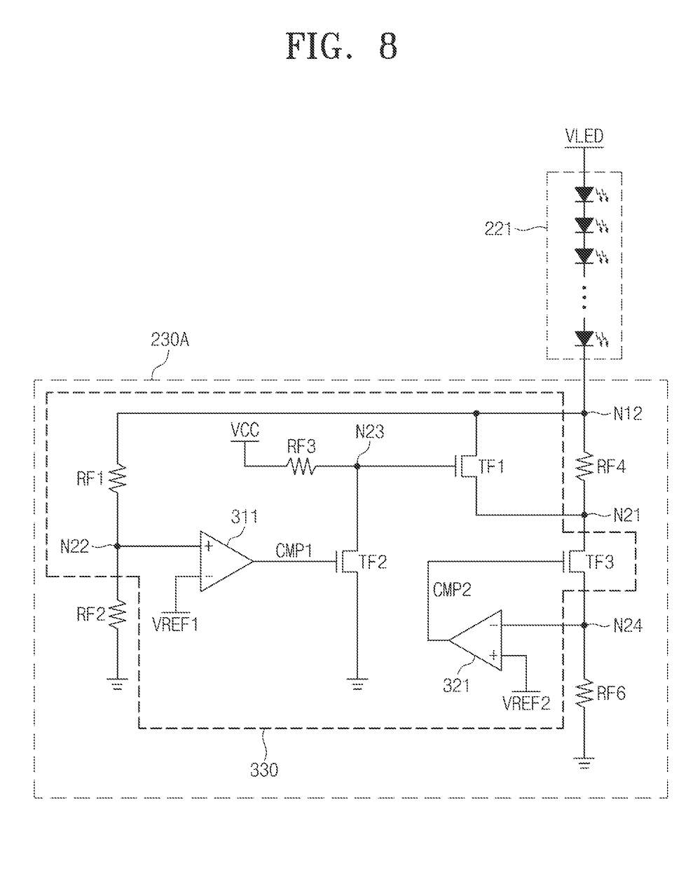

FIG. 8 is a diagram an example where a first controller shown in FIG. 4 is implemented with an integrated circuit.

Referring to FIG. 8, the remaining elements of a first controller 230A except for a second resistor RF2, a fourth resistor RF4, and a sixth resistor RF6 may be integrated in a single chip 330. This may mean that the elements RF2, RF4, and RF6 are placed outside of the single chip 330. Resistances of the resistors RF2, RF4, and RF6 are adjusted according to a characteristic of a light emitting diode string 221 by disposing the elements RF2, RF4, and RF6 outside of the single chip 330.

Referring back to example shown in FIG. 3, the controller includes the first controller 230A, the second controller 230B, and the third controller 230C. The first controller 230A, second controller 230B, and third controller 230C may be integrated in the form of a single chip. In this case, the resistors RF2, RF4, and RF6 of the first controller 230A and the resistors of the second and third controllers 230B and 230C that corresponds to the resistors RF2, RF4, and RF6 of the first controller may be disposed outside of single chips.

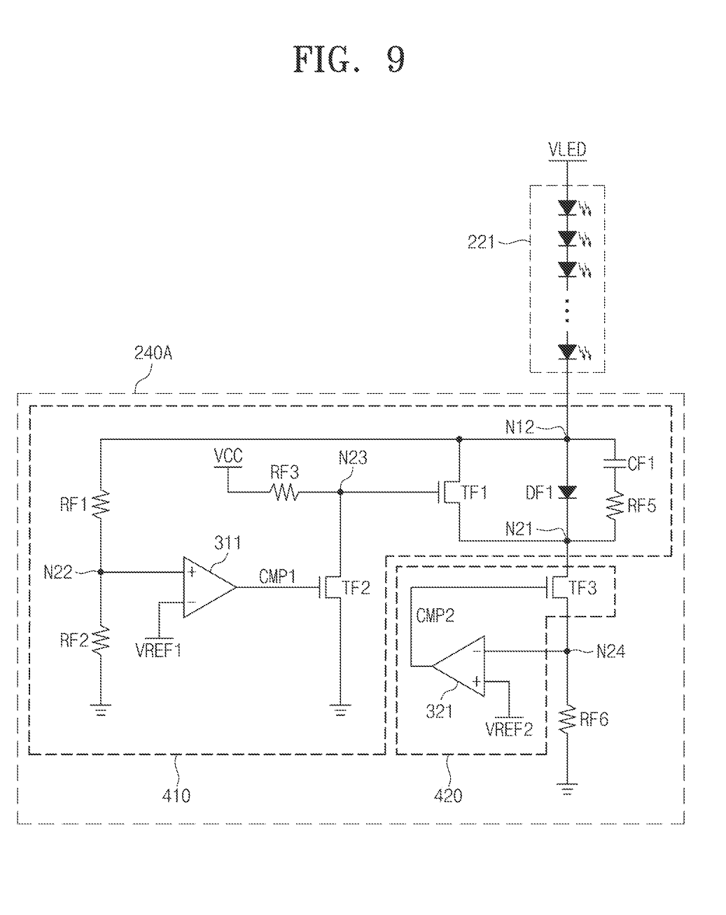

FIG. 9 is a circuit diagram schematically illustrating a first controller shown in FIG. 3, according to an exemplary embodiment of the inventive concept.

Referring to FIG. 9, a first controller 240A has a configuration similar to a first controller 230A shown in FIG. 4. In FIG. 9, the components that are identical to those shown in FIG. 4 are marked by the same reference numerals, and a description thereof is thus omitted. A first controller 240A includes an overvoltage controller 410 and a current controller 420.

The second node N12 and the first internal node N21 are connected with passive elements including a diode DF1, a capacitor CF1, and a fifth resistor RF5. The diode DF1 is connected between the second node N12 and a first internal node N21. The capacitor CF1 and the fifth resistor RF5 are connected in series between the second node N12 and the first internal node N21, in parallel with the diode DF1.

Like a first controller 230A shown in FIG. 4, if a voltage level of the second node N12 is at a normal level, the first transistor TF1 is turned on. When the first transistor TF1 is turned on, since a drain-source resistance Rds of the first transistor TF1 is smaller than a resistance of each of the diode DF1 and the fifth resistor RF5, a current of the second node N12 flows to the first internal Node and the third transistor TF3 via the first transistor TF1.

In contrast, if a voltage level of the second node N12 is higher than the normal level, the first transistor TF1 is turned off. At this time, a current of the second node N12 flows to the third transistor TF3 via a diode DF1, a capacitor CF1, and a resistor RF5. Thus, an overvoltage is limited from being supplied to the drain terminal of the third transistor TF3 when a voltage level of the second node N12 is higher than the normal level.

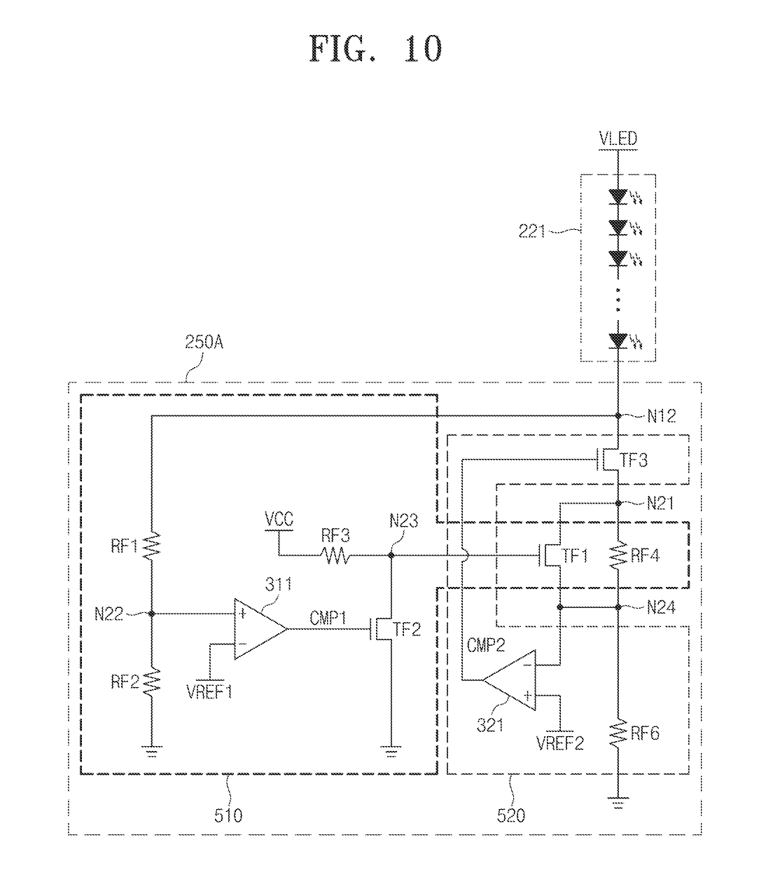

FIG. 10 is a circuit diagram schematically illustrating a first controller shown in FIG. 3, according to an exemplary embodiment of the inventive concept.

Referring to FIG. 10, a first controller 250A has a configuration similar to a first controller 230A shown in FIG. 4. In FIG. 10, the components that are identical to those shown in FIG. 4 are marked by the same reference numerals, and a description thereof is thus omitted. A first controller 250A includes an overvoltage controller 510 and a current controller 520.

Like a first controller 230A shown in FIG. 4, the overvoltage controller 510 contains first to fourth resistors RF1 to RF4, first and second transistors TF1 and TF2, and a comparator 311. The current controller 520 contains a third transistor TF3, a sixth resistor RF6, and a comparator 321. The third transistor TF3 of the current controller 520 is connected between a second node N12 connected to the other end of a light emitting diode string 221 and a first internal node N21 and has a gate electrode connected to the output of the second comparator 321. The sixth resistor RF6 is connected between a fourth internal node N24 and a ground voltage. The second comparator 321 compares a voltage of the fourth internal node N24 with a second reference voltage VREF2 to output a second comparison signal CMP2. The second comparison signal CMP2 is provided to a gate electrode of a third transistor TF3.

A fourth resistor RF4 of the overvoltage controller 510 is connected between the first internal node N21 and the fourth internal node N24. In exemplary embodiments, the fourth resistor RF4 is used as a passive element connected between the first internal node N21 and the fourth internal node N24, but the present inventive concept is not limited thereto. For example, passive element connected between the second node N12 and the first internal node N21 may include at least one of a capacitor, an inductor, a diode, and the like.

The first transistor TF1 is connected in parallel with the fourth resistor RF4 between the first internal node N21 and the fourth internal node N24 and has a gate electrode connected to a third internal node N23. The first resistor RF1 and the second resistor RF2 are sequentially connected in series between the second node N12 and a ground voltage.

The first comparator 311 compares a voltage of a second internal node N22, being a connection between the first resistor RF1 and the second resistor RF2, with a first reference voltage VREF1 and outputs a first comparison signal CMP1 as a comparison result. The third resistor RF3 is connected between a power supply voltage VCC and a third internal node N23. The second transistor TF2 is connected between the third internal node N23 and the ground voltage and has a gate electrode connected to receive the comparison signal CMP1.

When a voltage of the second node N12 is at a normal level, the first transistor TF1 is turned on; therefore, the current flows via the light emitting diode string 221, the third transistor TF3, the first transistor TF1, and the sixth resistor RF6. If a voltage of the second node N12 is higher than the normal level, the first transistor TF1 is turned off. The current flows via the light emitting diode string 221, the third transistor TF3, the fourth resistor RF4, and the sixth resistor RF6. Since the voltage is dropped by the fourth resistor RF4, an overvoltage may be limited from being supplied to the third transistor TF3.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative, and it is intended that the present invention cover the modifications and variations of this invention provided they come within the scope of the appended claims and their equivalents.

What is claimed is:

1. A backlight unit comprising:
a controller configured to generate a control signal;
a power converter configured to generate a light-source voltage in response to the control signal; and
at least one light emitting diode string connected between a first node and a second node and supplied with the light-source voltage from the first node,
wherein the controller comprises:
a current controller configured to adjust a current flow through the light emitting diode string; and
an overvoltage controller connected between the light emitting diode string and the current controller, the overvoltage controller comprising a passive element,
wherein the overvoltage controller is configured to connect the passive element between the second node and the current controller when a voltage of the second node of the light emitting diode is higher than a reference voltage.

2. The backlight unit of claim 1, wherein the current controller is connected between a first internal node and a ground voltage, and
the overvoltage controller is further configured to electrically connect the second node and the first internal node when a voltage of the second node is lower than the reference voltage, and
wherein the overvoltage controller is further configured to electrically connect the passive element between the second node and the first internal node when a voltage of the second node is higher than the reference voltage.

3. The backlight unit of claim 2, wherein the overvoltage controller further comprises:
a first resistor connected between the second node and a second internal node;
a second resistor connected between the second internal node and the ground voltage;
a first comparator configured to compare a voltage of the second internal node with a first reference voltage to output a first comparison signal;
a third resistor connected between a power supply voltage and a third internal node;
a second transistor connected between the third internal node and the ground voltage and having a gate electrode connected to receive the first comparison signal; and
a first transistor connected between the second node and the first internal node and having a gate electrode connected to the third internal node.

4. The backlight unit of claim 3, wherein the first resistor, the third resistor, the first comparator, the first transistor, and the second transistor are integrated in a single integrated chip.

5. The backlight unit of claim 1, wherein the passive element comprises a fourth resistor.

6. The backlight unit of claim 1, wherein the passive element comprises:
a diode connected between the second node and a first internal node;
a capacitor; and
a fifth resistor,
wherein the capacitor and the fifth resistor are connected in series between the second node and the first internal node in parallel with the diode.

7. The backlight unit of claim 3, wherein the current controller comprises:
a third transistor connected between the first internal node and a fourth internal node and having a gate electrode;
a sixth resistor connected between the fourth internal node and the ground voltage; and
a second comparator configured to compare a voltage of the fourth internal node with a second reference voltage to output a second comparison signal, the second comparison signal being applied to the gate electrode of the third transistor.

8. The backlight unit of claim 1, further comprising:
a plurality of third nodes; and
a plurality of light emitting diode strings each connected between the first node and a corresponding one of the plurality of third nodes and supplied with the light-source voltage via the first node,
wherein the controller further comprises:
a plurality of current controllers respectively corresponding to the plurality of light emitting diode strings; and
a plurality of overvoltage controllers respectively corresponding to the plurality of light emitting diode strings.

9. The backlight unit of claim 8, wherein each of the plurality of current controllers is configured to control a current flowing through a corresponding one of the plurality of light emitting diode strings.

10. The backlight unit of claim 9, wherein each of the plurality of overvoltage controllers comprises a passive element,
wherein each of the plurality of overvoltage controllers is configured to electrically connect the passive element between a third node of a corresponding light emitting diode string and a corresponding current controller when a voltage of the third node of the corresponding light emitting diode string is higher than the reference voltage.

11. A display device comprising:
a display panel comprising a plurality of pixels;
a driver circuit configured to control the display panel so as to display images; and
a backlight unit configured to supply a light to the display panel,
wherein the backlight unit comprises:
a controller configured to generate a control signal;
a power converter configured to generate a light-source voltage in response to the control signal; and
at least one light emitting diode string connected between a first node and a second node and supplied with the light-source voltage from the first node,
wherein the controller comprises:
a current controller configured to adjust a current flow through the light emitting diode string; and
an overvoltage controller connected between the light emitting diode string and the current controller, comprising a passive element,
wherein the overvoltage controller is configured to connect the passive element between the second node and the current controller when a voltage of the second node of the light emitting diode is higher than a reference voltage.

12. The display device of claim 11, wherein the current controller is connected between a first internal node and a ground voltage, and
the overvoltage controller is configured to electrically connect the second node and the first internal node when a voltage of the second node is lower than the reference voltage, and
wherein the overvoltage controller is further configured to electrically connect the passive element between the second node and the first internal node when a voltage of the second node is higher than the reference voltage.

13. The display device of claim 12, wherein the overvoltage controller further comprises:
a first resistor connected between the second node and a second internal node;
a second resistor connected between the second internal node and the ground voltage;
a first comparator configured to compare a voltage of the second internal node with a first reference voltage to output a first comparison signal;
a third resistor connected between a power supply voltage and a third internal node;
a second transistor connected between the third internal node and the ground voltage and having a gate electrode connected to receive the first comparison signal; and
a first transistor connected between the second node and the first internal node and having a gate electrode connected to the third internal node.

14. The display device of claim 13, wherein the first resistor, the third resistor, the first comparator, the first transistor, and the second transistor are integrated in a single integrated chip.

15. The display device of claim 11, wherein the passive element comprises a fourth resistor.

16. The display device of claim 11, wherein the passive element comprises:
a diode connected between the second node and a first internal node;
a capacitor; and
a fifth resistor,
wherein the capacitor and the fifth resistor are connected in series between the second node and the first internal node in parallel with the diode.

17. The display device of claim 13, wherein
the current controller comprises:
a third transistor connected between the first internal node and a fourth internal node and having a gate electrode;
a sixth transistor connected between the fourth internal node and the ground voltage; and
a second comparator configured to compare a voltage of the fourth internal node with a second reference voltage to output a second comparison signal, the second comparison signal being applied to the gate electrode of the third transistor.

18. The display device of claim 11, further comprising:
a plurality of third nodes; and
a plurality of light emitting diode strings each connected between the first node and a corresponding one of the plurality of third nodes and supplied with the light-source voltage via
the first node,
wherein the controller further comprises:
a plurality of current controllers respectively corresponding to the plurality of light emitting diode strings; and
a plurality of overvoltage controllers respectively corresponding to the plurality of light emitting diode strings.

19. The display device of claim 18, wherein each of the plurality of current controllers is configured to control a current flowing through a corresponding one of the plurality of light emitting diode strings.

20. The display device of claim 19, wherein each of the plurality of overvoltage controllers comprises a passive element,
wherein each of the plurality of overvoltage controllers is configured to electrically connect the passive element between a third node of a corresponding light emitting diode string and a corresponding current controller when a voltage of the third node of the corresponding light emitting diode string is higher than the reference voltage.
